(19) United States
(12) Patent Application Publication
(10) Pub. No.: US 2020/0141229 A1
(43) Pub. Date: May 7, 2020

(54) FAST RECOVERY NETWORK MANAGEMENT SCHEME FOR A DOWNHOLE WIRELESS COMMUNICATIONS SYSTEM

(71) Applicant: Schlumberger Technology Corporation, Sugar Land, TX (US)

(72) Inventors: Arnaud Croux, Boston, MA (US); Julius Kusuma, Fremont, CA (US)

(21) Appl. No.: 16/630,492

(22) PCT Filed: Jul. 12, 2018
(86) PCT No.: PCT/US2018/041719

§ 371 Date: Jan. 13, 2020

Related U.S. Application Data
(60) Provisional application No. 62/532,083, filed on Jul. 13, 2017.

(51) Int. Cl. E21B 47/14; H04L 12/721; H04W 72/04

(52) U.S. Cl. CPC E21B 47/14; H04W 72/042; H04L 45/127

(57) ABSTRACT

A network management technique for an acoustic communication system made up of a network of communication nodes is disclosed. Various of the nodes that are located intermediate a source node and a receiving node can detect communication failures in the network and then take action to efficiently recover from the failure, rather than acting only as repeaters. By allowing intermediate nodes to participate in recovery decisions, the speed and the quantity of real-time information transmission in the network can be improved.

### RELATED APPLICATIONS

This application claims priority to U.S. provisional application Ser. No. 62/532,083 filed Jul. 13, 2017, which is incorporated by reference herein in its entirety.

### BACKGROUND

Hydrocarbon fluids such as oil and natural gas are obtained from a subterranean geologic formation, referred to as a reservoir, by drilling a well that penetrates the hydrocarbon-bearing formation. Once a wellbore is drilled, various forms of well completion components may be installed in order to control and enhance the efficiency of producing the various fluids from the reservoir. Data representative of various downhole parameters, such as downhole pressure and temperature, are often monitored and communicated to the surface during operations before, during and after completion of the well, such as during drilling, perforating, fracturing and well testing operations. In addition, control information often is communicated from the surface to various downhole components to enable, control or modify the downhole operations.

Accurate and reliable communications between the surface and downhole components during operations can be difficult. Wired, or wireline, communication systems can be used in which electrical or optical signals are transmitted via a cable. However, the cable used to transmit the communications generally requires complex connections at pipe joints and to traverse certain downhole components, such as packers. In addition, the use of a wireline tool is an invasive technique which can interrupt productions or affect other operations being performed in the wellbore. Thus, wireless communication systems can be used to overcome these issues.

An example of a wireless system is an acoustic communication system. In acoustic systems, information or messages are exchanged between downhole components and surface systems using acoustic transmission mediums. As an example, a network of acoustic devices can be deployed downhole that uses tubing in the wellbore as the medium for transmitting information acoustically.

### BRIEF DESCRIPTION OF THE DRAWINGS

Certain embodiments of the invention are described with reference to the accompanying drawings, wherein like reference numerals denote like elements. It should be understood, however, that the accompanying drawings illustrate only the various implementations described herein and are not meant to limit the scope of various technologies described herein. The drawings show and describe various embodiments of the current invention.

FIG. 1 is a schematic representation of an example of a well system that includes an acoustic communications network, according to an embodiment.

FIG. 2 is a schematic representation of an example of an acoustic modem that can be deployed in the acoustic communications network of FIG. 1, according to an embodiment.

FIG. 3. is a flow diagram of an example of network management functionality that can be implemented in the acoustic modem of FIG. 2 to facilitate fast recovery from lost communications in the acoustic communications network of FIG. 1, according to an embodiment.

FIG. 4 is a timing diagram of an example of a communication session in the network of FIG. 1, according to an embodiment.

FIG. 5 is a timing diagram illustrating a conventional technique for recovering from a lost message during a communication session.

FIG. 6 is a timing diagram of an example of a fast recovery technique to recover from a lost message during a communication session, according to an embodiment.

FIG. 7 is a timing diagram of an example of a fast recovery technique that includes correction of a message error, according to an embodiment.

FIG. 8 is a timing diagram of an example of a fast recovery technique that includes requests for missing information, according to an embodiment.

FIG. 9 is a timing diagram of an example a network management technique that includes network coding of messages, according to an embodiment.

### SUMMARY

Certain embodiments of the present disclosure are directed to a method for communicating in a network. The method comprises transmitting a first query from a transmitting node to a receiving node via a downlink of an acoustic transmission medium interconnecting a network of acoustic communication nodes. An acoustic communication node intermediate the transmitting node and the receiving node receives a response to the query on an uplink of the acoustic transmission medium. The intermediate node stores in memory the response to the first query. When the intermediate node receives a second query on the downlink, the intermediate node determines if the stored response to the first query corresponds to the second query. If so, the intermediate node transmits the stored response on the uplink to respond to the second query. If not, the intermediate node transmits the second query on the downlink.

Further embodiments of the present disclosure are directed to an acoustic communication system that includes a plurality of acoustic communication nodes interconnected by an acoustic communications medium. The nodes include a source node, a receiving node and a plurality of intermediate nodes. The intermediate nodes are configured to receive a packet-based message that is part of a communication session between the source node and the receiving node. The intermediate nodes store information associated with the message in memory without regard to whether the message is addressed to that intermediate node. The intermediate nodes can use the stored information to recover a message that is lost in the communication session between the source node and the receiving node.

Yet further embodiments are directed to an acoustic network communication management method. In accordance with the method, a communication session is initiated between a source node and a receiving node. The source node transmits a message during the session that is directed to the receiving node via an acoustic transmission medium that interconnects a network of acoustic communication nodes. Those nodes include the source node, the receiving node and a plurality of intermediate nodes. The message transmitted by the source node includes information content intended for the receiving node. An intermediate node receives a message during the communication session that includes the information content and stores the information content without regard to whether the received message is addressed to the intermediate node. The intermediate node uses the stored information content to recover from a communication error during the communication session.

### DETAILED DESCRIPTION

In the following description, numerous details are set forth to provide an understanding of the present invention. However, it will be understood by those skilled in the art that the present invention may be practiced without these details and that numerous variations or modifications from the described embodiments may be possible.

In the specification and appended claims: the terms “connect”, “connection”, “connected”, “in connection with”, and “connecting” are used to mean “in direct connection with” or “in connection with via one or more elements”; and the term “set” is used to mean “one element” or “more than one element”. Further, the terms “couple”, “coupling”, “coupled”, “coupled together”, and “coupled with” are used to mean “directly coupled together” or “coupled together via one or more elements”. As used herein, the terms “up” and “down”, “upper” and “lower”, “upwardly” and downwardly”, “upstream” and “downstream”; “above” and “below”; and other like terms indicating relative positions above or below a given point or element are used in this description to more clearly describe some embodiments of the invention.

Communication systems for transmitting information between the surface and downhole components are faced with numerous challenges. As just one example, operations performed within downhole environments can introduce noise which can affect the quality of communications and, thus, the ability to reliably send and transmit messages in a wireless communication system. When the downhole environment is a hydrocarbon-producing well, noise levels can increase substantially due to the flow of the hydrocarbon production fluid. In general, provided that the Signal to Interference and Noise Ratio (“SINR”) or Signal to Noise Ratio (“SNR”) is sufficiently high, then messages can be reliably received and communicated. Likewise, when the SNR is too low, message quality can be degraded and difficulties encountered in reliably receiving a message.

One type of wireless communication system that can be deployed in a downhole environment is an acoustic communications system that uses an elastic medium as the communications path. The acoustic communication system can be used in multiple contexts, including testing, drilling or production operations, and can be used to transmit various types of information, such as information related to downhole measurements, tool status, actuation commands, etc. Generally, an acoustic communication system is considered for use when there is no obvious way to run a wired communications path between the communicating devices. The communicating devices may involve an operational team, where a computer is used in the vicinity of the well (e.g., on a rig, waveglider, etc.) or at a remote location that is indirectly connected to a communication module connected to the acoustic network. In other implementations, the acoustic communication network operates autonomously between the various oil and gas equipment.

In general, an acoustic communications network is composed of an arrangement of acoustic modems that receive and transmit messages. The acoustic modems use a pipe string (or tubing) as the elastic transmission medium. The communication network is established by connecting a plurality of acoustic modems to tubing at axially spaced locations along the string. Each modem includes a transducer that can convert an electrical signal to an acoustic signal (or message) that is then communicated using the tubing as the transmission medium. An acoustic modem within range of a transmitting modem receives the acoustic message and processes it, including by demodulating and decoding the message. An example of an acoustic communication network 100 is shown schematically in FIG. 1.

Referring to FIG. 1, a network 100 of acoustic modems 102 a-f is deployed in a wellbore 104 so that communications can be exchanged between a surface control and telemetry system 106 and downhole equipment along both a downlink (from the surface to the downhole equipment) and an uplink (from the downhole equipment to the surface). The surface control and telemetry system 106 can include processing electronics, a memory or storage device and transceiver electronics to transmit and receive messages to and from the network 100 via a wired connection 108. In various embodiments, the processing electronics can include a signal conditioner, filter analog-to-digital converter, microcontroller, programmable gate array, etc. The memory or storage device can store telemetry data received from the downhole equipment so that it can be processed and analyzed at a later time. Yet further, the memory or storage device can store instructions of software for execution by the processing electronics to generate messages to control and monitor performance of a downhole operation.

The modems 102a-f are acoustically coupled to an elastic medium, such as tubing 110, which can be a jointed pipe string, production tubing or a drillstring, that provides the acoustic communications path. It should be understood, however, that the elastic medium may be provided by other structures, such as a tubular casing 112 that is present in the wellbore 104.

In addition to the modems 102a-f, the installation shown in FIG. 1 includes a packer 114 positioned on the tubing 110 at a region of interest 116. Various pieces of downhole equipment for testing and the like are connected to the tubing 110, either above or below the packer 114, such as a test valve 118 above the packer and a sensor 120 below the packer 114.

Two types of modems generally are deployed in the acoustic network 100. The first type of modem is one that is connected to an external tool (e.g., test valve 118 or sensor 120) at a fixed depth. This type of modem is referred to as an “Interfaced Modem” (“IM”). The second type of modem is used to repeat (or forward), as well as to amplify (or boost), an acoustic message. This second type of modem is referred to as a “Repeater Modem” (“RM”).

The repeater modems are used to account for the fact that wireless communication signals between surface systems and devices located furthest from the surface generally lack the strength to reach their destination. In many downhole applications, acoustic signals can experience an attenuation of about 10 decibels/1000 feet. Accordingly, when acoustic noise is present in the environment, it can be substantial relative to the strength of the acoustic signal.

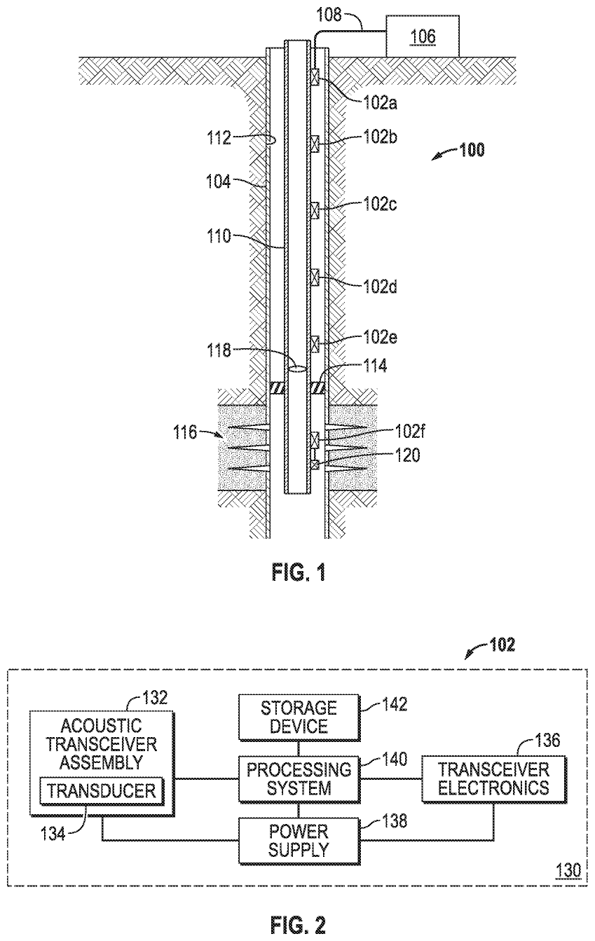

A schematic illustration of a modem 102 is illustrated in FIG. 2. Modem 102 including a housing 130 that supports an acoustic transceiver assembly 132 that includes electronics and a transducer 134 which can be driven to create an acoustic signal in the tubing 110 and/or excited by an acoustic signal received from the tubing 110 to generate an electrical signal. The transducer 134 can include, for example, a piezoelectric stack, a magneto restrictive element, and/or an accelerometer or any other element or combination of elements that are suitable for converting an acoustic signal to an electrical signal and/or converting an electrical signal to an acoustic signal. The modem 102 also includes transceiver electronics 136 for transmitting and receiving electrical signals. Power can be provided by a power supply 138, such as a lithium battery, although other types of power supplies are possible, including supply of power from a source external to the modem 102.

The transceiver electronics 136 are arranged to receive an electrical signal from and transmit an electrical signal to the downhole equipment, such as the sensor) and the valve 118. The electrical signal can be in the form of a digital signal that is provided to a processing system 140, which can encode and modulate the signal, amplify the signal as needed, and transmit the encoded, modulated, and amplified signal to the transceiver assembly 132. The transceiver assembly 132 generates a corresponding acoustic signal for transmission via the tubing 110.

The transceiver assembly 132 of the modem 102 also is configured to receive an acoustic signal transmitted along the tubing 110, such as by another modem 102. The transceiver assembly 132 converts the acoustic signal into an electric signal. The electric signal then can be passed on to processing system 140, which processes it for transmission as a digital signal to the downhole equipment. In various embodiments, the processing system 140 can include a signal conditioner, filter, analog-to-digital converter, demodulator, modulator, amplifier, encoder, decoder, microcontroller, programmable gate array, etc. The modem 102 also can include a memory or storage device 142 to store data received from the downhole equipment so that it can be transmitted or retrieved from the modem 102 at a later time. Yet further, the memory or storage device 142 can store instructions of software for execution by the processing system 140 to perform the various modulation, demodulation, encoding, decoding, etc. processes described above and the network management techniques that will be described below. Still further, the memory or storage device 142 can store information corresponding to received messages according to a memory management scheme implemented by the modem 102.

Returning again to FIG. 1, to account for SNR limitations, communications between the surface and a downhole component often are performed as a series of hops. This is accomplished by positioning RMs at axially spaced intervals (e.g., 1000 ft.) along the acoustic communications path (e.g., a tubing) so that the RMs can forward acoustic messages to the final IM node. Because a communication system is designed to operate reliably indifferent types of noise conditions, the spacing between RMs often is configured to account for the worst case noise scenario.

Acoustic messages that are transmitted in downhole applications can include queries or commands that are sent from a surface system to one or more nodes. The surface system includes a surface modem that transmits the message to the addressed IM node via a route of RM nodes that has been determined when the network was established (e.g., during a network discovery phase). In many systems, redundancies are built in so that more than one modem along the route can be capable of receiving a given message.

In embodiments, communications on network 100 are packet-based. In general, a packet includes a preamble that includes information that enable the receiving nodes in the network 100 to detect the arrival of a new packet. That is, a portion of the message will contain network information from which the receiving modem can determine whether the message is addressed to it or another modem. If the message is addressed for another device, then the receiving modem amplifies it and acoustically retransmits it along the tubing. This process repeats until the communication reaches its intended destination. In embodiments, the information in the preamble also can be used to synchronize the transmitter and the receiver in the sending and receiving modems.

A packet also includes a header that contains information regarding the routing of the packets. Depending on the network strategy, the header can include the identifications of the source modem (i.e., an IM) connected to the device, the transmitting modem (e.g., an RM), the recipients, the direction of propagation, and/or the final destination modem (e.g., a surface modem or requestor), as examples. The header also can include an identifier associated with the packet and keys to decode the data portion of the packet, which contains the actual information that is communicated between the initial (or source) transmitting modem to the final destination modem.

In the network 100 illustrated in FIG. 1, when a message is detected, the receiving modem attempts to demodulate and decode it. As mentioned, the preamble of the message packet will include network information so that, when demodulated and decoded, the receiving modem can determine whether the message is locally addressed to it. If so, the modem manages the message by either forwarding it or executing the command. If the message calls for retransmission of a message, such as forwarding a message to another modem along the route or responding to a command or query, then the modem will transmit a new message that has been encoded and modulated in an appropriate manner.

The ability of the modem to reliably decode a received message is related to the SNR of the received signal. As mentioned above, the SNR can fluctuate substantially during an operation, particularly when flow of a production fluid is present. When the SNR is low, the modem may not be able to reliably decode a received message, resulting in a communication failure.

In known communication networks, the RM nodes generally do not have the functionality (or intelligence) to detect a communication failure, but instead simply repeat and relay the information that has been received. As a consequence, if a local packet is lost, the entire query between the initial transmitting modem and the final destination must be repeated, resulting in a great deal of latency and uncertainty in the network.

Accordingly, embodiments of the present disclosure are directed to an acoustic communication system made up of a network of communication nodes. Various of the nodes can detect communication failures in the network and then take action to efficiently recover from the failure. For example, in embodiments disclosed herein, a network management scheme is implemented by adding intelligence to RM nodes so that they do not act only as repeaters. Rather, one or more of the RM nodes in the network 100 are configured to detect communication failures and to make message routing decisions in an attempt to efficiently recover from the failure. In general, the network management scheme decentralizes the routing function by allowing the RM node to participate in recovery decisions, where an objective is to improve the speed and the quantity of real-time information transmission in the network 100.

For example, in one implementation, if an RM node detects a communication loss in the network 100, it can re-route the message in order to achieve efficient recovery. In another implementation, the RM node stores information in memory relating to communications that the RM node previously has observed and/or received in the network 100. When a communication failure is detected, the RM node then can make a decision based on the stored information in order to recover from the communication failure. For example, the RM node can decide to either forward a query or reply to a query, based on historical messages stored in memory. To illustrate, if the RM node receives a query that is addressed to that RM node and the reply to the query already is stored in the RM node's memory, then the RM node can infer that this same query was not successful in the past. In such a case, the RM node can then make the decision to reply directly to the query using the information stored in its memory without propagating the message to the destination. As another example, even if an RM node is not addressed by the message, but if it has the ability to detect a communication failure elsewhere in the network, it can make the decision to process the message and forward it.

To facilitate the description of the network management schemes described herein, references to a communication session should be understood to refer to an attempt to transmit information from one node A to another node B. For example, a communication session can be made up of a query from node A to node B and then a reply from node B to node A. Or, as another example, a communication session can be a pre-configured streaming mode from node B to node A without the need of a query from node A to initiate the transmission of information. In this description, RM nodes are located intermediate nodes A and B to facilitate communications between the nodes.

Existing network management schemes have two characteristics that embodiments described herein improve on. First, within a communication session, an RM node that receives a message (or packet) but is not the addressed recipient for the message will not consider the information content of the packet. Second, in between two communication sessions, the RM nodes do not exchange information.

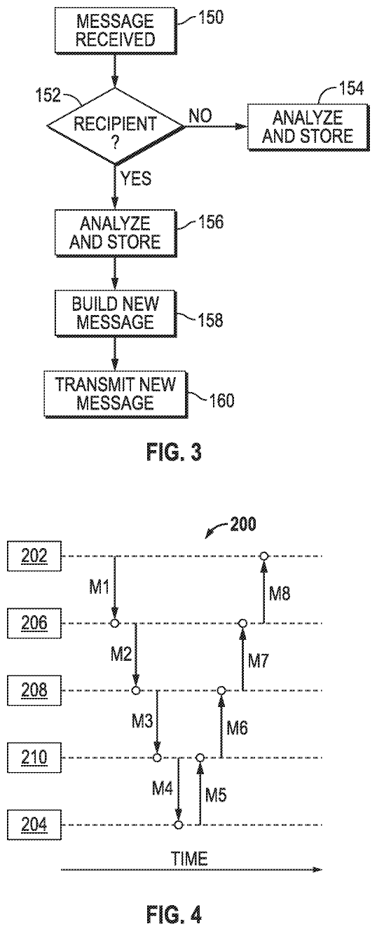

FIG. 3 is a flow diagram that generally illustrates embodiments of a network management scheme in which functionality is implemented in an RM node in order to facilitate recovery from a lost message in a communication session. As shown in FIG. 3, the RM nodes do not operate simply as repeaters. Rather, each RM node is configured to analyze packets in order to improve the network latency and communication latency.

To that end, embodiments of the network management scheme include a technique to identify a query and the response or answer to a query so that an RM node can infer the success (or failure) of previous packet receptions. To facilitate the inference process, the RM node can implement a memory management scheme, whereby the RM node stores the data of a received packet in its memory 142 without regard to whether the RM node is the addressed recipient of the packet. By storing the data, the RM node can later use the packet data if subsequently received packets indicate a need to do so (i.e., the occurrence of a communication failure in the network). In embodiments, the memory management scheme implemented by the RM node can store the data with reference to metadata (e.g., message identification, query properties such as what is asked) about the message and the actual message content (e.g., the byte stream representing the measurement data).

FIG. 3 illustrates a flow diagram of example network management functionality that can be implemented in an RM node to facilitate recovery from a lost message during a communication session. In FIG. 3, a packet (or message) is received by the RM node (block 150). Regardless of whether the RM node is the addressed recipient of the message (block 152), the RM node analyzes the content of the message and stores the content in its memory 142 (blocks 154, 156). If the RM node is the addressed recipient of the packet (blocks 152, 156), then, at the RM node's transmitting time, the RM node builds a new message packet and determines the next packet to transmit (block 158). The packet is defined by its routing properties and by its information content. The time to transmit can be determined following the reception of a packet or it can be based on internal timing in the RM node.

When building the new message, the RM node makes transmission decisions based on the previous information stored in the memory 142. The RM node uses the stored information to speed up the effective data rate of the telemetry system by reducing the transmission of redundant information in the acoustic channel. For example, if the RM node receives a query for which a corresponding answer is stored in its memory 142, the RM node does not relay the query for delivery to the intended destination (e.g., an IM node), but instead routes the stored answer to the initial requestor (e.g., a surface modem).

As another example, in the context of a communication session that consists of streaming multiple messages, the RM node monitors the status of reception of a batch of packets. In this context, the RM node may build a message that is a request for missing information or build a message that includes the information already received or the RM node may simply wait for the next packet to be received. As yet another example, the RM node can build a new message with content that is generated by applying a coding scheme across the batch of messages to be transmitted in order to reduce the amount of information that will be sent on the communication channel. Once the new message is built, the message is transmitted on the network (block 160).

FIGS. 4-9 are timing diagrams of exemplary communication sessions that are provided to highlight the improvement in network communication efficiency that is afforded by the network management techniques described above. The timing diagram of FIG. 4 is an example of a communication session 200 that consists of a round trip query, where a requestor node 202 initiates a query M1 that is intended for destination node 204. In this example, node 202 is the requesting node which is closest to the surface in FIG. 1. Node 204 is an IM node that interfaces with downhole equipment, such as the sensor 120 in FIG. 1. Intermediate nodes 206, 208 and 210 are RM nodes that relay the query M1 to node 204 as messages M2, M3 and M4, respectively, and relay the response M5 from node 204 to node 202 as messages M6, M7 and M8, respectively.

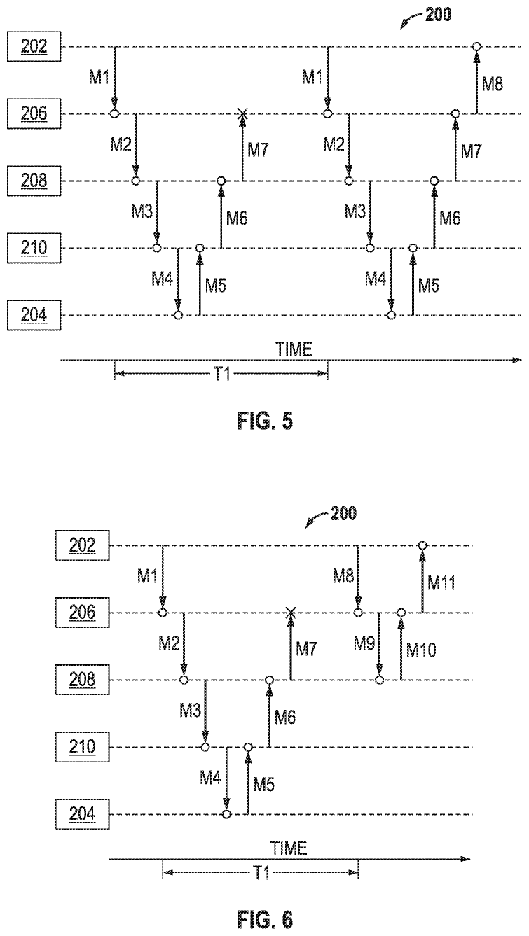

FIG. 5 is a timing diagram of a known solution from recovering from a lost message in the communication session 200. Here, message M7 is not received by node 206. Thus, after a period of time T1 in which node 202 does not receive a response to its query M1, node 202 reinitiates the query by resending M1.

FIG. 6 is a timing diagram of an example of implementations of the network management solution that uses the flagging of queries and answers in order to recover from a lost message. In this implementation, each RM node in the network includes the intelligence to determine whether the previous uplink message was successfully transmitted to the surface. To that end, when the uplink is being used for a communication session, each RM node stores in its memory 142 the downhole information associated with the query flag. Then, if a RM node receives a downlink query flagged with an associated answer that is stored in its memory 142, the RM node uplinks the stored answer without propagating the downlink query.

In FIG. 6, the communication session 200 again is illustrated in which message M7 is lost by RM node 206 and not received by requestor node 202. After time period T1, the requestor node 202 retransmits the query as message M8. Upon receipt of a message M9 on the downlink, the RM node 208 determines it previously has stored the response in its memory 142. Thus, rather than propagating the query on to the destination node 202, the RM node 208 responds to message M9 by building a new message M10 that includes the answer to the query. The message M10 is relayed to the requestor node 202 as message M11.

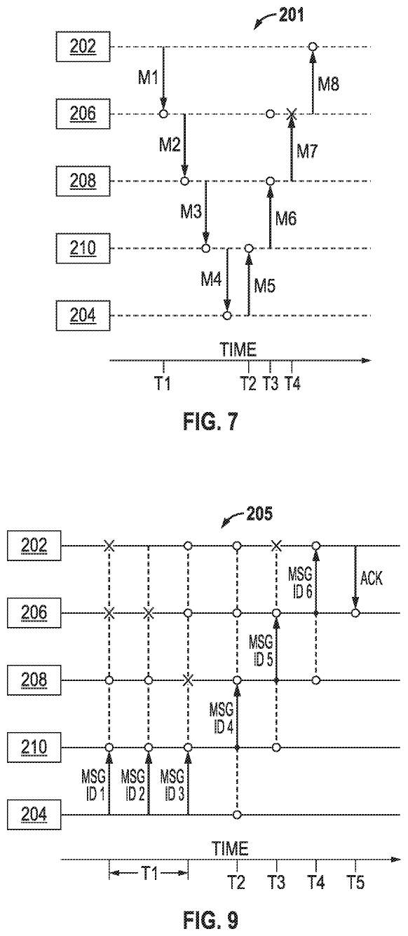

FIG. 7 illustrates an embodiment of the network management scheme in which the RM nodes are configured to correct an erroneously decoded packet during a communication session. In a communication session, each message content often is received multiple times by each node, with multiple packets that repeat the message content. The main reason for this inefficiency is that the network is designed for the worst case scenario where the acoustic conditions change so quickly that a great deal of redundancy is implemented. In each packet, the data portion often is the longest part of the message. Consequently, the data portion frequently is the part of the message that is lost. When this occurs, an RM node generally can decode the preamble information of the packet but not the actual information content. Thus, by configuring the RM node to determine whether the information content corresponding to the query has already been received and stored, the erroneous decoded information content can be corrected.

As shown in a communication session 201 in FIG. 7, at time T1, requestor node 202 initiated a query M1 directed to destination node 204 that was relayed by each of RM nodes 206, 208, 210 as messages M2, M3 and M4, respectively. At time T2, destination node 204 responded to the query with a message M5 routed to RM node 210 that included the requested information content. At time T3, RM node 210 relayed the message M5 as M6 to RM node 208. Both RM node 208 and RM node 206 received message M6. In this example, RM node 206 successfully decoded and stored the information content of the message M6. However, RM node 208, which also had received the message M6, erroneously decoded the content portion. When RM node 208 relays the erroneously decoded message M7 to RM node 206 at time T4, node 206 determines whether it had previously received the information content and, if so, compares the decoded content of message M7 with the decoded content of message M6 that it has stored in memory. In this way, errors in message decoding can be detected and corrected. Thus, as shown in FIG. 7, RM node 206 generates a new message M8 based on the corresponding correctly decoded information that node 206 previously had stored in its memory 142. RM node 206 then transmits message M8 to the requestor node 202.

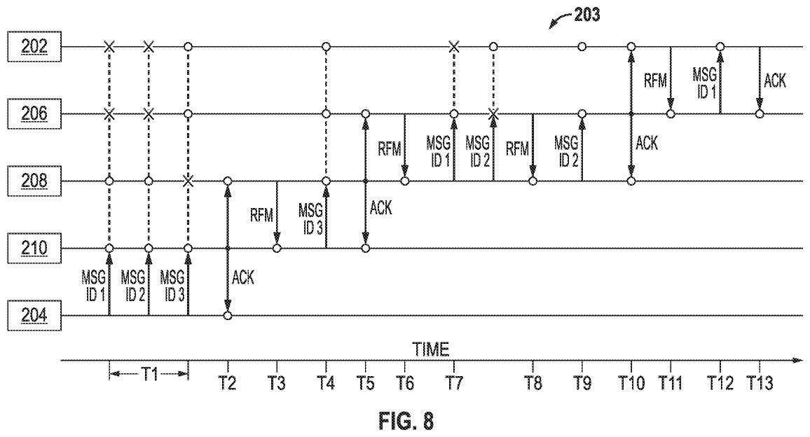

FIG. 8 extends the scheme of FIG. 7 in order to handle batches of multiple packets that are streamed in the same communication session. In this example of a communication session 203, it is assumed that a reliable acknowledgment and request protocol is established between the network of nodes. In FIG. 8, the RM nodes maintain in their respective memories 142 the content of messages that have been received in the same communication session 203. When the time comes for a RM node to transmit, the RM node only requests the information that the RM node is missing.

For example, during source node 204's transmitting time T1, a batch of three messages identified by message identifiers ID1, ID2 and ID3 are transmitted to and successfully received by RM node 210. Message ID1 and Message ID2 are also received and successfully decoded by RM node 208, but not by nodes 202, 206. Message ID3 is not successfully received by RM node 208, but it is successfully received by RM node 206 and requesting node 202.

At time T2, RM node 210 sends an acknowledgement (ACK) message to source node 204 and RM node 208 indicating that it has received the batch of messages ID1, ID2 and ID3. At time T3, because RM node 206 also previously successfully received messages ID1 and ID2 (but not message ID3), RM node 206 takes over the communication session and responds to the ACK message with a request for more (RFM) message asking RM node 210 to send it only message ID3.

At time T4, RM node 210 transmits message ID3 to RM node 208, and message ID3 also is successfully received by RM node 206 and requestor node 202. At time T5, RM node 208 sends an ACK message to RM nodes 210 and 206 indicating that it has the batch of messages ID1, ID2 and ID3 ready to transmit.

At time T6, because RM node 206 already has message ID3, RM node 206 takes over and responds with an RFM message asking for messages ID1 and ID2. At time T7, RM node 208 transmits messages ID1 and ID2 to RM node 206. Message ID1 is successfully received by RM node 206, but not by requestor node 202. Message ID2 is successfully received by requestor node 202, but not by RM node 206. At time T8, RM 206 therefore transmits an RFM message to RM node 208 for message ID2. At time T9, RM node 208 re-transmits message ID2 to RM node 206. At time T10, RM node 206 transmits an ACK message indicating to RM node 208 and requestor node 202 that the batch of messages has been received.

At time T11, because requester node 202 has determined that the only message missing from the batch is message ID1, node 202 transmits an RFM message to RM node 206 requesting only message ID1. At time T12, RM node 206 responds to the RFM message with message ID1. At time T13, requestor node 202 transmits an ACK message, indicating that the complete batch has been received.

The example communication session 203 illustrated in FIG. 8 shows a batch of three messages. However, it should be understood that the network management scheme can be extended to batches of any number of messages.

FIG. 9 is a timing diagram of yet another example implementation of the network management scheme. In this example, network coding is applied to a batch of messages in a communication session 205 to introduce redundancy into transmissions so that a receiving node can recover from missing information. In this example implementation, instead of transmitting raw messages, each node transmits messages that are random linear combinations of the original messages in their memory, referred to as degrees of freedom (dofs). If the dofs are composed of M data packets, then a receiving node can decode the message after it has received M dofs. Network coding reduces the complexity of feedback for reliable transmission schemes. For example, instead of tracking which packets are received, a transmitting node only needs to know whether enough dofs have been received.

To illustrate, in FIG. 9, during time period T1, the source node 204 transmits a batch of original messages ID1, ID2, ID3, one at a time. When a packet is received by an RM node, it is stored in the node's memory 142. In this example, three dofs are sufficient for a receiving node to transmit a newly encoded message that is a linear combination of the previously received messages. When an RM node has an opportunity to transmit, and it has sufficient dofs in memory, it sends a random linear combination of all messages in its memory. Decoding is performed using Gaussian elimination.

As shown in FIG. 9, original messages ID1 and ID2 are received by RM nodes 210 and 208. Original message ID3 also is received by RM node 210 and 206, but not by RM node 208. Thus, at time T2, since RM node 210 has three dofs, it builds a new message ID4 that is a random linear combination of original messages ID1, ID2 and ID3 stored in its memory 142.

Upon receipt of coded message ID4, RM node 208 now has three dofs and, at time T3, it builds and transmits a new message ID5 that is a random linear combination of original messages ID1, ID2 and coded message ID4. Upon receipt of coded message ID5, RM node 206 (which previously received original message ID1 and coded message ID4) has sufficient dofs to transmit. Thus, at time T4, RM node 206 builds and transmits new coded message ID6, which is a random linear combination of original message ID1, coded message ID4 and coded message ID5. Upon receipt of coded message ID6, the requester node 202 (which previously received original message ID3 and coded message ID4) has sufficient information to decode the batch of information originally transmitted by source node 204. At time T5, requestor node 202 sends an ACK message indicating that the complete message batch has been received.

With network coding, a transmitting node generates and then transmits a linear combination of the initial messages. Each linear combination is unique so the same message is not transmitted more than once. The linear combinations of the initial packets mix and randomize the initial information content into the transmitted packets.

To decode the initial N messages, the nodes need to have received N linearly independent encoded packets. This is less restrictive than the traditional approach that requires receipt of exactly the N initial messages. Also, to decode the N messages, the node needs to know the encoding coefficients. Those coefficients can be randomly generated in advance and preprogrammed in the nodes or they can be transmitted as side information in the packets.

In embodiments, the nodes do not need to decode the initial messages. Rather, at the node's transmitting time, it can generate a new linear combination of the M encoded messages (M<N) already received. The unique objective is that the final receiver node obtains N degrees of freedom as quickly as possible, in order to decode the N initial messages.

Fast recovery network management schemes that implement network coding can offer several advantages, including an increase of the speed of the communications and an increase in the efficiency of network routing. For example, in downhole acoustic telemetry applications, noise in the acoustic channel varies greatly. Thus, the serial network is designed to operate reliably in the worst case. As a consequence, due to the repeating strategy, the communication nodes often receive the same packet multiple times. With network coding, the independence of the packets is improved substantially, thus limiting the reception of redundant packets. Thus, the nodes can more quickly receive all the information needed to decode the initial information transmitted by the source node. Hence, telemetry speed is increased.

With respect to routing efficiency, the implementation of network coding eliminates the need for the nodes to receive the N initial packets. However, N independent packets from the N initial packets is a sufficient condition. Thus, when sending batches of packets, routing is simplified because the transmitter only needs to know that the receiver needs more information as opposed to what information the receiver has missed.

Further, in known repeating approaches to routing in a vertical network, a packet sent by a source node must flow sequentially. Often, the same packet is received at least three times by each node. To limit this inefficient redundancy, some routing strategies implement adaptive routing algorithm to bypass some nodes based on current network conditions. However, adaptive routing algorithms often require “discovery” time. This discovery time generates latency, and may reduce the overall efficiency of the system.

In contrast, network coding does not need to adapt the routing of the messages. Instead of bypassing redundant nodes, network coding involves sending fewer redundant packets, hence improving the speed of the telemetry.

The network management techniques described herein are particularly useful for use in hydrocarbon well environments. During oil and gas operations, the acoustic conditions change rapidly, which poses challenges with acoustic communications. The noise can be due to fluid flow in the string of pipes, or due to mechanical activity such as wireline, coil-tubing, or due to external factors such as rotation, friction and pipe banging. Because of these ever-changing noise conditions, loss of some of the point-to-point communications is inevitable and expected.

For oil and gas operations, the network management techniques described herein can be used for offshore and onshore operations. In offshore operations, the noise conditions are known to be more challenging around the seabed and in the riser section. In the riser section, external parameters such as wind, waves, and current generate movements of the riser and the landing string. Those movements can induce shocks of the riser with the landing string, which, in turn, generates acoustic noise in the landing string. Accordingly, embodiments described above can operate to provide a more reliable communication subsurface, as well as to provide the ability to implement acoustic communication in the riser section.

It should be further understood that the techniques described herein can be implemented in a variety of wireless communications systems, and that the physical layer of the communication is not limited to the acoustic telemetry system that has been described above. Further, single or multi-carrier modulation systems can be used in any wireless communication system. As an example, orthogonal frequency division multiplexing (OFDM) is a modulation technique that is suitable for frequency selective channels. However, embodiments disclosed herein are not limited to the use of any particular type of modulation system.

While the present disclosure has been disclosed with respect to a limited number of embodiments, those skilled in the art, having the benefit of this disclosure, will appreciate numerous modifications and variations there from. It is intended that the appended claims cover such modifications and variations as fall within the true spirit and scope of the invention.

What is claimed is:

1. A method for communicating in a network, comprising:
transmitting a first query from a transmitting node to a receiving node via a downlink of an acoustic transmission medium interconnecting a network of acoustic communication nodes;
receiving, by an acoustic communication node intermediate the transmitting node and the receiving node, a response to the query on an uplink of the acoustic transmission medium;
storing in memory, by the acoustic communication node, the response to the first query;
receiving, by the acoustic communication node, a second query on the downlink;
determining, by the acoustic communication node, if the stored response to the first query corresponds to the second query; and
if so, transmitting the stored response on the uplink to respond to the second query;
if not, transmitting the second query on the downlink.

2. The method as recited in claim 1, further comprising:
receiving, by the acoustic communication node, a first response on the uplink that is not addressed to the acoustic communication node;
storing in memory, by the acoustic communication node, the first response;
receiving, by the acoustic communication node, a second response on the uplink that is addressed to the acoustic communication node;
determining, by the acoustic communication node, whether the second response is part of a same communication session as the first response;
if so, identifying an error in the second response by comparing the second response to the first response stored in memory; and
if an error is identified in the second response, using the first response stored in memory to transmit on the uplink, by the acoustic communication node, a corrected response.

3. The method as recited in claim 1, wherein the acoustic communication node stores the response in memory without regard for whether the response is addressed to the acoustic communication node.

4. The method as recited in claim 1, wherein the acoustic transmission medium is a tubing deployed in a hydrocarbon well.

5. An acoustic communication system, comprising:
a plurality of acoustic communication nodes interconnected via an acoustic communications medium, the acoustic communication nodes including a source node, a receiving node, and a plurality of intermediate nodes,
wherein the intermediate nodes are configured to:
receive a packet-based message on the acoustic communications medium that is part of a communication session between the source node and the receiving node;
store information associated with the packet-based message in memory without regard to whether the packet-based message is addressed to the intermediate node; and
use the stored information to recover a packet-based message that is lost in the communication session between the source node and the receiving node.

6. The system as recited in claim 5, wherein the intermediate nodes further are configured to use the stored information to correct an error in a packet-based message that occurs in the communication session between the source node and the receiving node.

7. The system as recited in claim 5, wherein the stored information comprises content intended for the receiving node, and wherein upon receipt of a query requesting the content from the source node, the intermediate node transmits a packet-based message with the stored information to the receiving node and does not forward the query to the source node.

8. The system as recited in claim 5, wherein the communication session comprises a batch of packet-based messages transmitted from the source node to the receiving node, and wherein the intermediate nodes are configured to determine whether the intermediate node has received the batch of packet-based messages and, if not, transmitting a request for only messages missing from the batch.

9. The system as recited in claim 8, wherein the intermediate nodes are configured to take over the communication session if the intermediate node has stored information associated with any one of the packet-based message in the batch.

10. The system as recited in claim 5, wherein the communication session comprises a batch of packet-based messages transmitted from the source node to the receiving node, and wherein the intermediate nodes are configured to store information associated with each of the packet-based messages in the batch, combine the stored information associated with each of the packet-based messages into a new packet-based message, and transmit the new packet-based message on to the communications medium.

11. The system as recited in claim 10, wherein the new packet-based message includes a random linear combination of the stored information.

12. The system as recited in claim 5, wherein the acoustic communication medium is a tubing deployed in a hydrocarbon well.

13. The system as recited in claim 12, wherein the source node is an acoustic modem coupled to a downhole equipment, and wherein the information stored in memory comprises telemetry data associated with the downhole equipment.

14. An acoustic network communication management method, comprising:
initiating a communication session between a source node and a receiving node;
transmitting, during the communication session, a message from the source node to the receiving node via an acoustic transmission medium interconnecting a network of acoustic communication nodes that include the source node, the receiving node and a plurality of intermediate nodes, the message including information content intended for the receiving node;
receiving, by an intermediate node, a message during the communication session that includes the information content;
storing, by the intermediate node, the information content without regard to whether the received message is addressed to the intermediate node; and
using, by the intermediate node, the stored information content to recover from a communication error during the communication session.

15. The method as recited in claim 14, wherein the intermediate node uses the stored information content to correct an error in a message that the intermediate node subsequently receives during the communication session.

16. The method as recited in claim 15, wherein the error is an error in decoding the information content made by another intermediate node.

17. The method as recited in claim 15, further comprising:
receiving, by the intermediate node during the communication session, a query requesting the information content from the source node;
determining, by the intermediate node whether the stored information content is the requested information content; and,
if so, transmitting a message to the receiving node with the stored information content and not forwarding the query to the source node.

18. The method as recited in claim 14, wherein the communication session comprises a batch of messages transmitted from the source node to the receiving node, and the method further comprises:
determining, by the intermediate node, whether it has received the complete batch of messages; and,
if not, transmitting a request for only messages missing from the batch.

19. The method as recited in claim 14, wherein the communication session comprises a batch of messages transmitted from the source node to the receiving node, and the method further comprises:
storing, by the intermediate node, information content associated with each of the messages in the batch;
transmitting, by the intermediate node, a new message on the acoustic communications medium that comprises a random linear combination of the information content for all of the messages in the batch.
